(19) United States
(12) Patent Application Publication
(10) Pub. No.: US 2007/0233532 A1
(43) Pub. Date: Oct. 4, 2007

(54) BUSINESS PROCESS ANALYSIS APPARATUS

(75) Inventors: Shunichiro KOISO, Kawasaki (JP); Yukihiko Furumoto, Kawasaki (JP); Makoto Kobayashi, Kawasaki (JP); Tsukasa Tenma, Kawasaki (JP); Hirooki Hayashi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/550,159

(22) Filed: Oct. 17, 2006

(30) Foreign Application Priority Data
Mar. 28, 2006 (JP) 2006-087420

(51) Int. Cl. G06F 17/50

(52) U.S. Cl. 705/7

(57) ABSTRACT

A business process analysis apparatus that can predict an activity improvement effect with a certain accuracy and can preferentially apply improvements to activities having higher predicted improvement effect values among the individual activities forming the entire business process. The business process analysis apparatus has an activity database in which at least an activity quantity, an output type, and an output quantity are stored by being associated with one another for each of the activities forming the business process, and performs a process including: selecting an activity belonging to the business process under analysis as an analysis target activity; acquiring the activity quantity, output type, and output quantity of the analysis target activity; retrieving any activity having the same output type as the output type of the analysis target activity; obtaining activity efficiency based on the activity quantity and output quantity of the retrieved activity; determining reference efficiency based on at least one activity efficiency thus obtained; and computing activity improvement effect by calculating a difference between the activity quantity of the analysis target activity and the activity quantity that would be required if the analysis target activity were performed with the reference efficiency. The above process is performed on every analysis target activity.

### BACKGROUND OF THE INVENTION

1. Field of the Invention

The present invention relates to a business process analysis apparatus that can predict an activity improvement effect with a certain accuracy and can preferentially apply improvements to activities having higher predicted, improvement values.

2. Description of the Related Art

A method known as ABC (Activity Based Costing) is widely used to improve business processes. In the ABC method, each business process is broken down into smaller units called activities, and cost management is performed by accurately evaluating the cost of each activity. Then, in improving the activities, improvements are applied to the respective activities on an individual basis, in decreasing order of cost, and managed by the ABC method. Japanese Unexamined Patent Publication No. 2003-67452, Japanese Unexamined Patent Publication No. 2003-308421, and Japanese Unexamined Patent Publication No. 2004-310564 propose methods for performing such tasks efficiently.

In the methods described in the above prior art documents, activities to be improved are determined based on the cost (money or time). However, such activities do not necessarily provide a high improvement efficiency (effectiveness in improving the activities). For example, in the activity flow shown in FIG. 1, if the activity time is considered as the cost, in the prior art methods the activity time 5 H required to perform the activity A is compared with the activity time 2.5 H required to perform the activity B, and the activity A requiring the longer activity time is chosen as a target for improvement. However, if some improvement has already been done on the activity A, it will be difficult to further improve the activity A. On the other hand, if an improvement has not yet been done on the activity B, an appreciable result can be readily obtained by improving the activity B.

Further, if an activity to be improved is discovered, as the improvement is performed by relying on the skill and know-how of a person in charge of improvement work, the improvement may end up being done insufficiently or, conversely, the improvement may be done more than necessary, resulting in a waste of cost. A method for discovering an activity for which an appreciable result can be obtained by improvement is not known in the prior art, nor is there known a method that can readily predict the effect of an improvement.

In the case where the activity time is considered as the cost, if a certain activity is improved and its activity time shortened, the improvement may not always lead to the improvement of the business process as a whole, since the business process comprises many activities that diverge and merge in a complicated manner, one activity sometimes having to wait to merge with another activity and so on.

For example, in a business process having an activity flow such as shown in FIG. 2, when the sum of the activity time required to perform the activity B and the activity time required to perform the activity C is longer than the activity time required to perform the activity D, any improvement done to shorten the activity time for the activity D will have no effect on the business process as a whole, because the process has to wait for the activities B and C to complete before starting the activity E. In this case, in a practical business process having a complicated activity flow, it is difficult to judge that the activity B and/or the activity C are the activities to be improved and that there is no need to improve the activity D.

### SUMMARY OF THE INVENTION

The present invention has been devised in view of the above problem, and an object of the present invention is to provide a business process analysis apparatus that can predict an activity improvement effect with a certain accuracy without relying on the skill or know-how of a person in charge of improvement work and can apply improvements preferentially to activities having higher improvement effect prediction values among the individual activities forming the entire business process.

To achieve the above object, according to the present invention, there is provided a business process analysis apparatus comprising: an activity database in which at least activity quantity, output type, and output quantity are stored by being associated with one another for each of a plurality of activities forming a business process; a target activity selecting unit for selecting an activity belonging to the business process under analysis as an analysis target activity from within the activity database; a target activity information acquiring unit for acquiring the activity quantity, output type, and output quantity of the analysis target activity; a reference efficiency determining unit for retrieving from the activity database any activity having the same output type as the output type of the analysis target activity, obtaining activity efficiency based on the activity quantity and output quantity of the retrieved activity, and determining reference efficiency based on at least one activity efficiency thus obtained; an activity improvement effect computing unit for computing an activity improvement effect by calculating a difference between the activity quantity of the analysis target activity and the activity quantity that would be required if the analysis target activity were performed with the reference efficiency; and a unit for causing the target activity information acquiring unit, the reference efficiency determining unit, and the activity improvement effect computing unit to perform processing on every analysis target activity selected by the target activity selecting unit.

In one preferred mode, the activity database stores the plurality of activities forming the business process by associating each activity with another, and the system further comprises: a critical path detecting unit for detecting a critical path in the business process under analysis; an activity improving unit for reflecting the activity improvement effect in the activity quantity of the activity that yields the greatest activity improvement effect of all the activities belonging to the critical path; and a business process improvement effect computing unit for computing business process improvement effect by causing the critical path detecting unit and the activity improving unit to perform processing until the activity improvement effect becomes zero for all the activities belonging to the critical path.

Further, according to the present invention, there are also provided a method to be implemented in the above system, and a storage medium storing a program for implementing the above system.

According to the present invention, by making a comparison with an activity having the same output type, it becomes possible to predict activity improvement effect with a certain accuracy without relying on the skill or know-how of a person in charge of improvement work. Further, as improvements can be applied preferentially to activities having higher improvement effect prediction values among the individual activities forming the entire business process, an improvement of the business process can be performed efficiently.

### BRIEF DESCRIPTION OF THE DRAWINGS

Other features and advantages of the present invention will be apparent from the following description with reference to the accompanying drawings, in which:

FIG. 1 is a diagram showing one example of an activity flow;

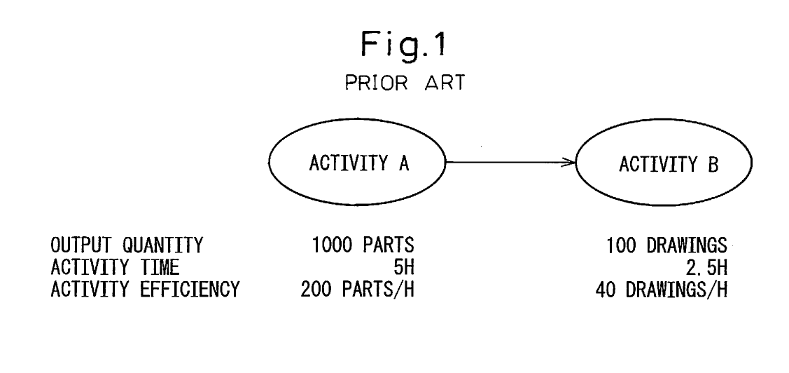

FIG. 2 is a diagram showing another example of the activity flow;

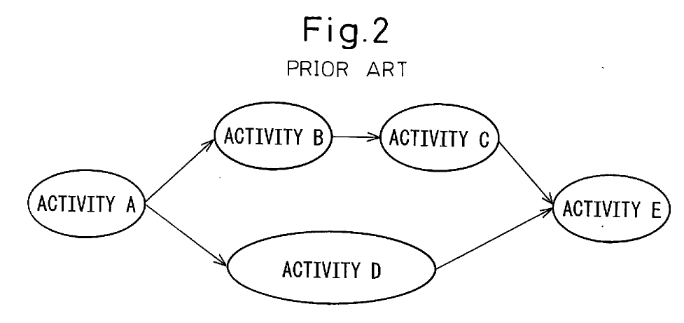

FIG. 3 is a diagram showing the hardware configuration of one embodiment of a business process analysis apparatus according to the present invention;

FIG. 4 is a flowchart illustrating a processing procedure for an activity improvement prediction routine;

FIG. 5 is a diagram showing an example of an activity database;

FIG. 6 is a diagram showing an example of a display presenting the results of activity improvement prediction;

FIG. 7 is a flowchart illustrating a processing procedure for a business process improvement prediction routine;

FIG. 8 is a diagram showing an example of an activity database;

FIG. 9 is a diagram showing an activity flow in a business process;

FIG. 10A is a diagram showing the initial results of activity improvement prediction, and FIG. 10B is a diagram showing the times initially required along activity paths;

FIG. 11A is a diagram showing the results of activity improvement prediction after a first activity improvement, and FIG. 11B is a diagram showing the times required along the respective activity paths after the first activity improvement;

FIG. 12A is a diagram showing the results of activity improvement prediction after a second activity improvement, and FIG. 12B is a diagram showing the times required along the respective activity paths after the second activity improvement;

FIG. 13A is a diagram showing the results of activity improvement prediction after a third activity improvement, and FIG. 13B is a diagram showing the times required along the respective activity paths after the third activity improvement;

FIG. 14A is a diagram showing the results of activity improvement prediction after a fourth activity improvement, and FIG. 14B is a diagram showing the times required along the respective activity paths after the fourth activity improvement; and

FIGS. 15A and 15B are diagrams showing an example of a display presenting the results of business process improvement prediction.

### DESCRIPTION OF THE REFERRED EMBODIMENTS

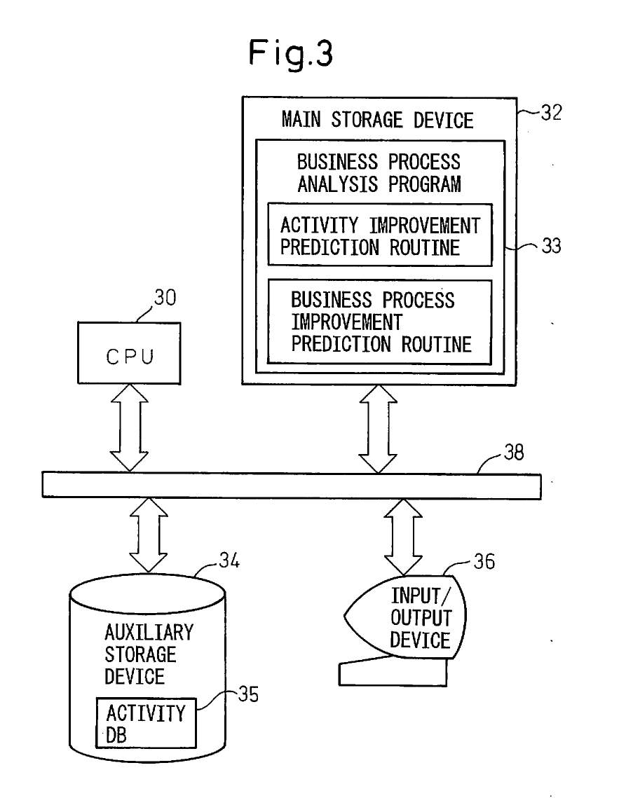

An embodiment of the present invention will be described below with reference to the accompanying drawings. FIG. 3 is a diagram showing the hardware configuration of one embodiment of a business process analysis apparatus according to the present invention. As shown, the business process analysis apparatus comprises a central processing unit (CPU) 30, a main storage device 32, an auxiliary storage device 34, an input/output device 36, and a system bus 38 interconnecting them. The CPU 30 controls the entire operation of the system by executing programs stored in the main storage device 32. The input/output device 36 comprises a keyboard, a mouse, a display, etc. A business process analysis program 33 according to the present invention, as well as control programs such as OS (Operating System), is stored in the main storage device 32.

The auxiliary storage device 34 comprises a hard disk or the like and stores an activity database (DB) 35 based on which processing is performed in accordance with the present invention. The activity DB 35 manages name of activity, output type, output quantity, activity quantity, activity efficiency, and other information (such as name of business process, name of preceding activity, name of succeeding activity, etc.) necessary for each activity forming a business process.

The business process analysis program 33 includes an activity improvement prediction routine and a business process improvement prediction routine. The activity improvement prediction routine receives user instructions via the input/output device 36, and computes, from the information stored in the activity DB 35, a prediction value predicting the effect of activity improvement in the business process under analysis. The business process improvement prediction routine receives user instructions via the input/output device 36, and computes from the information stored in the activity DB 35 a prediction value predicting the effect that the result of improvement of each activity will have on the business process as a whole. The results computed by the activity improvement prediction routine and business process improvement prediction routine are stored in the main storage device 32 or on the auxiliary storage device 34 and/or presented for viewing by the user via the input/output device 36.

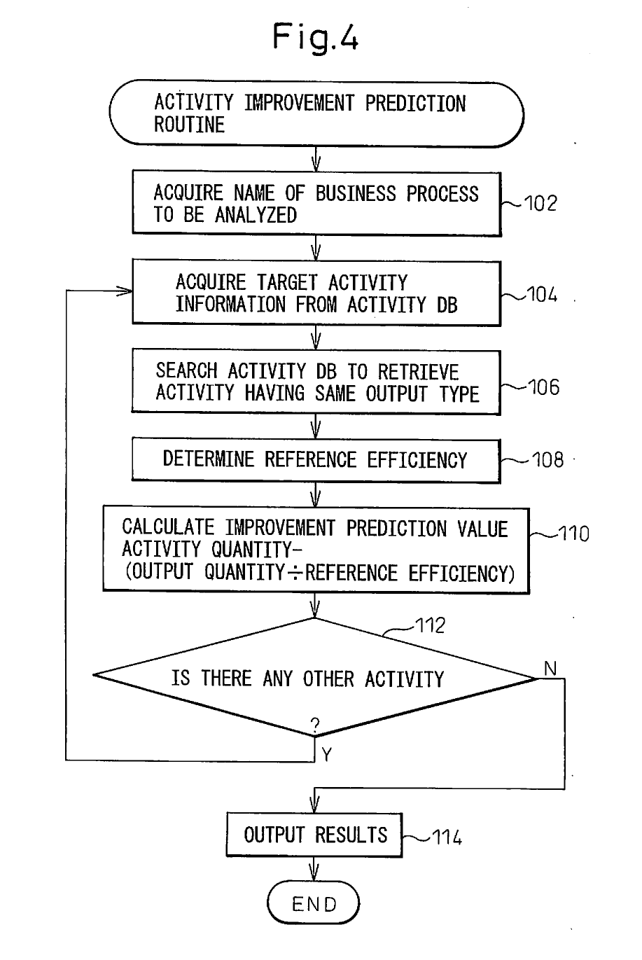

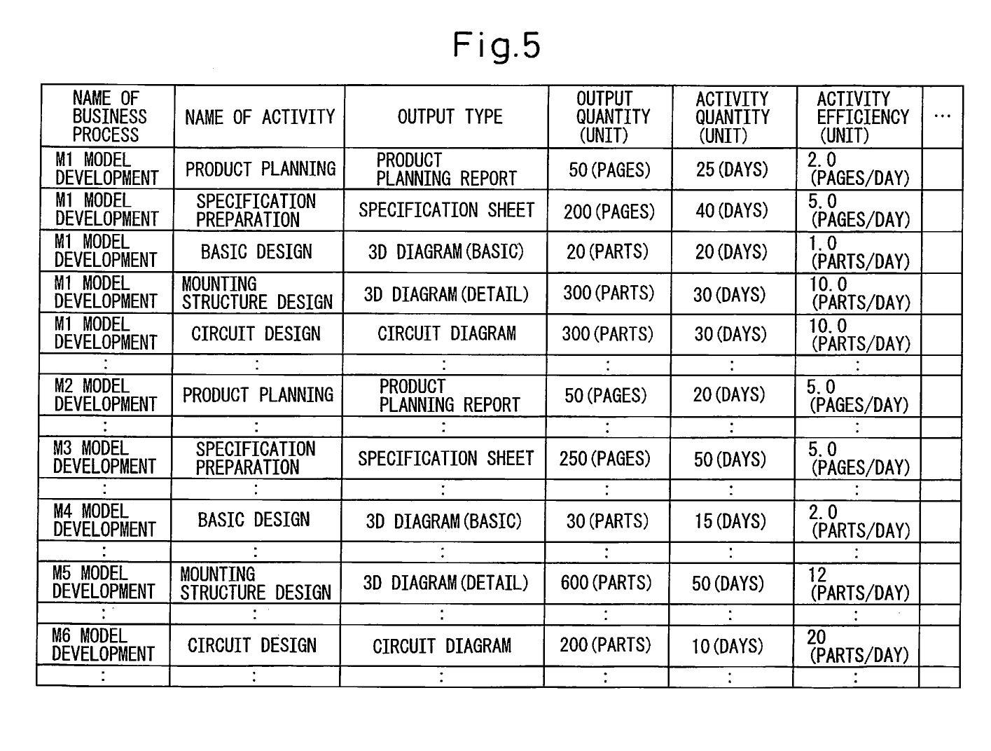

FIG. 4 is a flowchart illustrating a processing procedure for the activity improvement prediction routine. FIG. 5 is a diagram showing an example of the activity DB 35 based on which the routine performs processing. As shown in FIG. 5, the activity DB stores records each consisting of such fields as “NAME OF BUSINESS PROCESS,” “NAME OF ACTIVITY,” “OUTPUT TYPE,” “OUTPUT QUANTITY,” “ACTIVITY QUANTITY,” “ACTIVITY EFFICIENCY,” etc. The activity efficiency is obtained by dividing the output quantity by the activity quantity, and need not necessarily be stored at all times but may be obtained by calculation when the need arises.

First, in the activity improvement prediction routine, the name of the business process to be analyzed, entered by the user, is acquired via the input/output device 36 (step 102). As an example, it is assumed that the business process “M1 MODEL DEVELOPMENT” has been specified here. Next, the activity improvement prediction routine acquires, from the activity DB, information related to an activity whose process name is “M1 MODEL DEVELOPMENT” (step 104). First, information related to the “PRODUCT PLANNING” activity in the business process “M1 MODEL DEVELOPMENT” is acquired. Next, using the output type “PRODUCT PLANNING REPORT” of the “PRODUCT PLANNING” activity in the business process “M1 MODEL DEVELOPMENT” as the key, the activity improvement prediction routine searches the activity DB to retrieve any activity having the same output type (step 106).

Next, based on the “ACTIVITY EFFICIENCY” of the activity retrieved in step 106, the activity improvement prediction routine determines the value of the activity efficiency (reference efficiency) that serves as a reference for analysis (step 108). It is assumed here that a condition specifies that the activity efficiency of the activity having the highest activity efficiency of all the activities having the same output type be adopted as the reference activity efficiency; therefore, in the illustrated example, the activity efficiency “2.5 (pages/day)” of the “PRODUCT PLANNING” activity in the business process “M2 MODEL DEVELOPMENT” is adopted as the reference efficiency. On the other hand, if the condition specifies that the average activity efficiency taken over all the activities having the same output type is adopted as the reference efficiency, the average value of the activity efficiencies of all the activities retrieved in step 106 is taken as the reference efficiency. Here, it is assumed that the condition (maximum value, average value, etc.) for determining the reference efficiency is given in advance by the user via the input/output device 36.

Then, the activity improvement prediction routine calculates the improvement prediction value for the analysis target activity (step 110), based on the activity quantity and the output quantity of the activity acquired in step 104 and the value of the activity efficiency determined in step 108. In the illustrated example, the “PRODUCT PLANNING” activity in the business process “M1 MODEL DEVELOPMENT” requires 25 days to complete a 50-page product planning report (activity efficiency=2.0 (pages/day)) at the present time, but it can be predicted that if the efficiency is improved to the same level as the reference efficiency, i.e., the activity efficiency “2.5 (pages/day)” of the “PRODUCT PLANNING” activity in the business process “M2 MODEL DEVELOPMENT,” then the 50-page product planning report can be completed in 20 days=50 (pages)÷2.5 (pages/day). The difference between the present activity quantity and the prediction value after the improvement, i.e., 25 (days)−20 (days)=5 (days), is the effect achieved by the improvement.

Next, the activity improvement prediction routine determines whether there is any other activity whose process name is “M1 MODEL DEVELOPMENT” (step 112); if there is any such activity, the routine returns to step 104 to repeat the above processing. If there is no such activity, the results are output to the input/output device 36 and/or the main storage device 32 or the auxiliary storage device 34 (step 114), and the routine is terminated.

In the above activity improvement prediction routine, steps 102 and 104 respectively constitute a target activity selecting means for selecting an activity belonging to the business process under analysis as an analysis target activity from within the activity database, and a target activity information acquiring means for acquiring the activity quantity, output type, and output quantity of the analysis target activity. Steps 106 and 108 constitute a reference efficiency determining means for retrieving from the activity database any activity having the same output type as the output type of the analysis target activity, obtaining activity efficiency based on the activity quantity and output quantity of the retrieved activity, and determining the reference efficiency based on at least one activity efficiency thus obtained. Step 110 constitutes an activity improvement effect computing means for computing an activity improvement effect by calculating a difference between the activity quantity of the analysis target activity and the activity quantity that would be required if the analysis target activity were performed with the reference efficiency. Step 112 constitutes a means for causing the target activity information acquiring means, the reference efficiency determining means, and the activity improvement effect computing means to perform processing on every analysis target activity selected by the target activity selecting means.

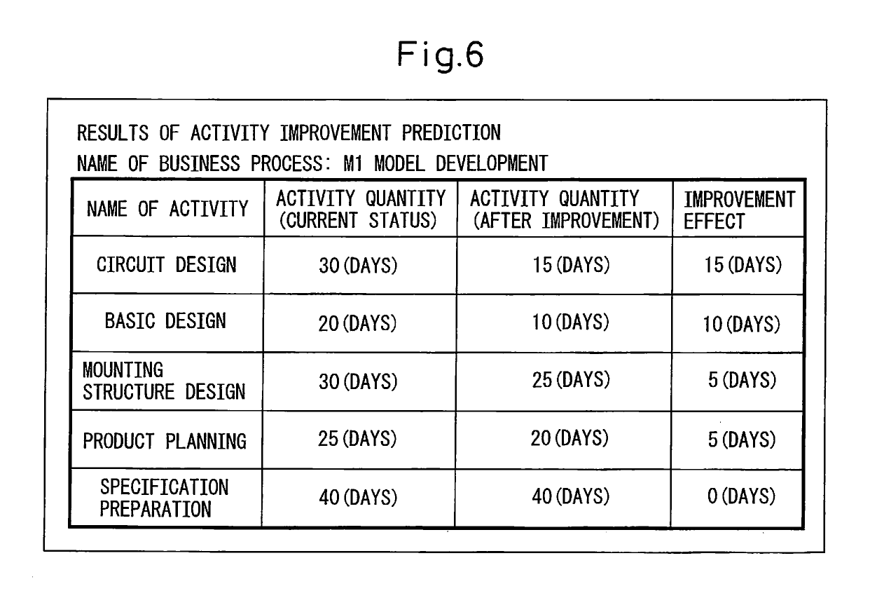

FIG. 6 shows an example of a display presenting the results of activity improvement prediction after performing the above processing on all the target activities. In this example, the activities are listed in decreasing order in terms of improvement effect. One can readily see that, of all the activities improved to the reference efficiency level, the improvement effect of the “CIRCUIT DESIGN” activity is the highest at “15 days” and an enormous effect can be obtained by improving this activity in the business process “M1 MODEL DEVELOPMENT”. On the other hand, the “SPECIFICATION PREPARATION” activity already has the activity efficiency comparable to the reference efficiency, and its improvement effect is therefore “0 day” which shows that it is difficult to further improve this activity.

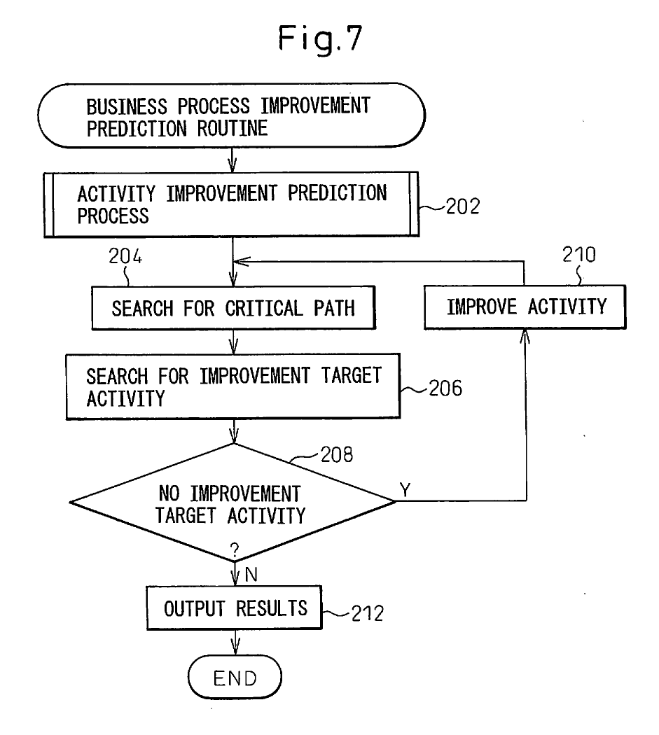

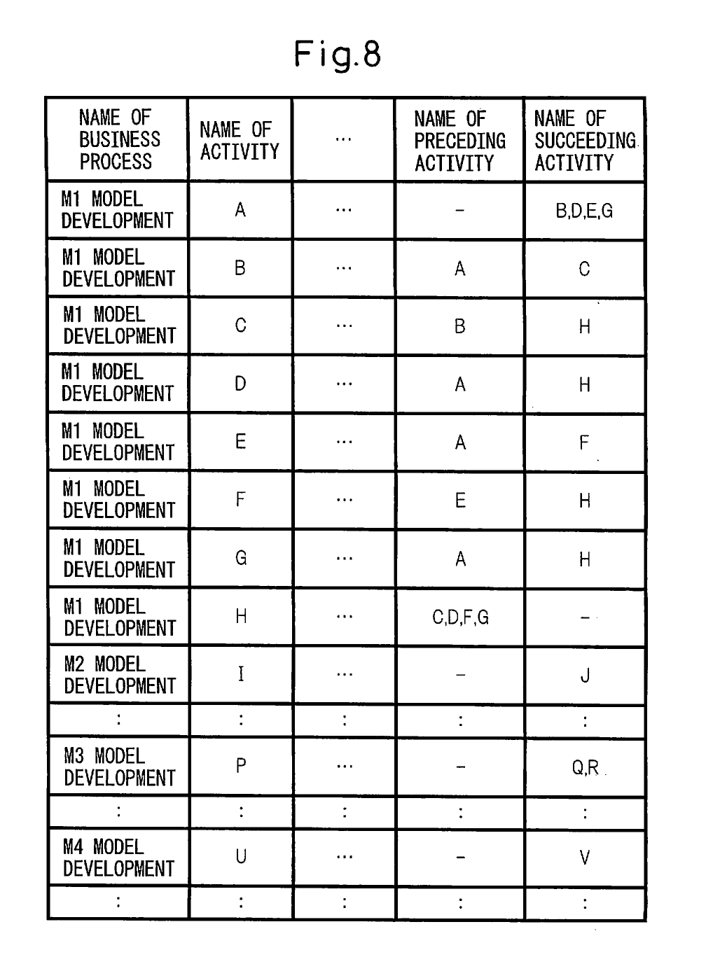

FIG. 7 is a flowchart illustrating a processing procedure for the business process improvement prediction routine. FIG. 8 is a diagram showing an example of the activity DB 35 based on which the routine performs processing. The activity DB shown in FIG. 8 also includes the fields of “OUTPUT TYPE,” “OUTPUT QUANTITY,” and “ACTIVITY EFFICIENCY”, but these fields are not shown. In the activity DB of FIG. 8, “NAME OF PRECEDING ACTIVITY” and “NAME OF SUCCEEDING ACTIVITY” are stored for each activity in order to manage the plurality of activities forming the business process by associating them with one another.

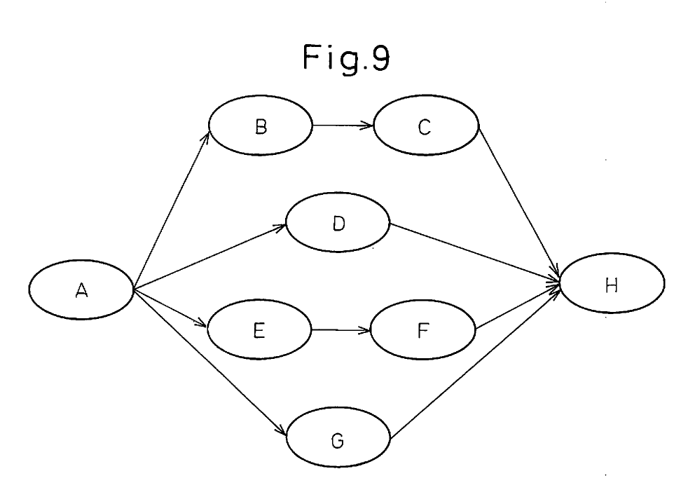

It is assumed here that, as an example, the business process “M1 MODEL DEVELOPMENT” has been specified as the business process to be analyzed to predict the effect (shortening of time) that influences the entire process. In this case, it is seen from the activity DB of FIG. 8 that the business process “M1 MODEL DEVELOPMENT” can be constructed in the form of the activity flow shown in FIG. 9.

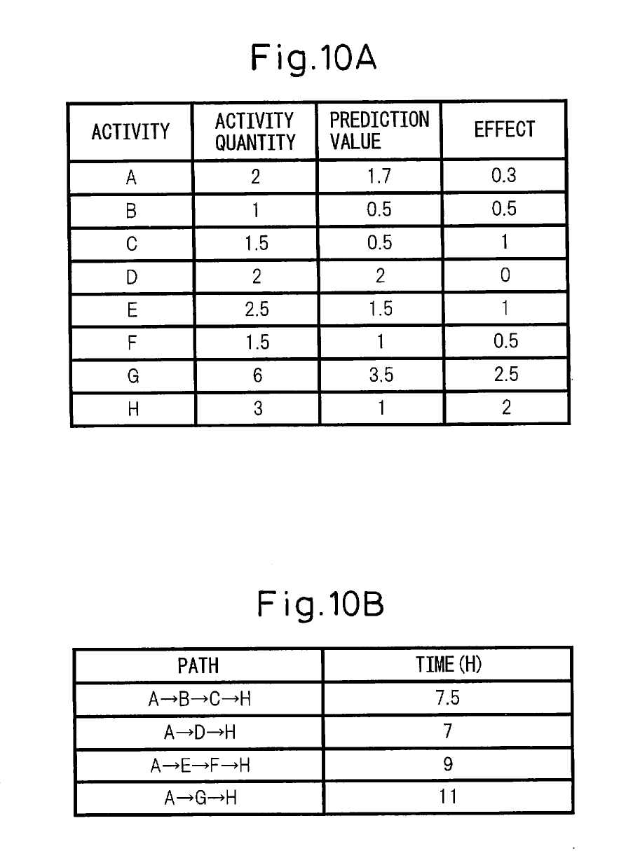

First, the business process improvement prediction routine calls the earlier described activity improvement prediction routine (FIG. 4) to perform the activity improvement prediction process, and acquires the results of activity improvement prediction (current activity quantity, prediction value for activity quantity after improvement, and improvement effect) for the business process “M1 MODEL DEVELOPMENT” to be analyzed here (step 202). It is assumed that the results of activity improvement prediction shown in FIG. 10A have been obtained.

Next, the business process improvement prediction routine searches for a critical path in the business process under analysis (step 204). More specifically, all the paths from activity A to activity H (FIG. 9) are searched for, and the time that each path requires is computed, thereby acquiring the times required along the respective activity paths as shown in FIG. 10B. A known method can be used to search for all the paths. Based on FIG. 10B, the business process improvement prediction routine determines that the critical path is A→G→H.

Next, the business process improvement prediction routine searches for an improvement target activity within the critical path (step 206). More specifically, by referring to the results of activity improvement prediction shown in FIG. 10A, it is determined that the activity that yields the highest improvement effect within the path A→G→H is the activity G. Any path with the effect of “0” is not chosen as a target for improvement.

Then, the business process improvement prediction routine determines (in step 208) whether an improvement target activity has been detected in step 206 and, if any such activity has been detected, the process proceeds to step 210; otherwise, the process proceeds to step 212. In the first cycle of the process, the activity G is detected as the improvement target activity, and the process therefore proceeds to step 210.

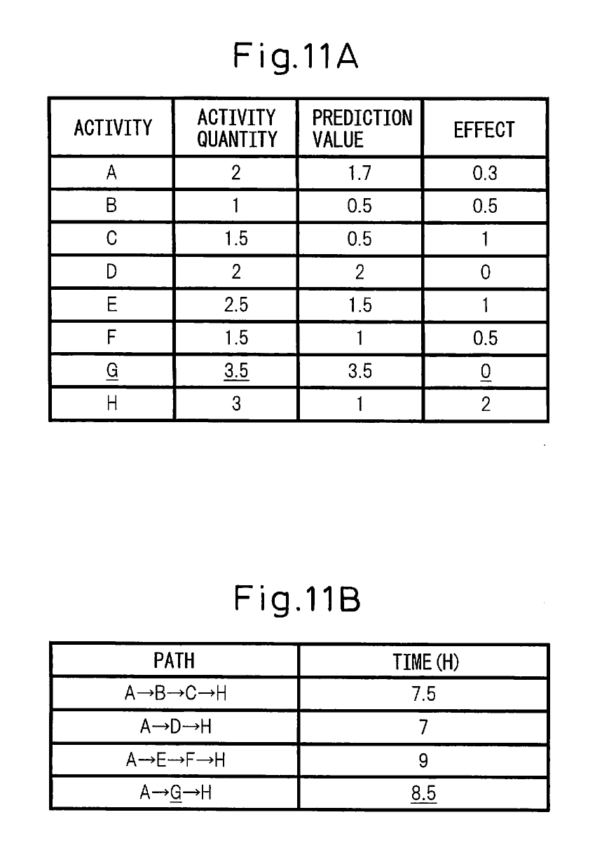

In step 210, the business process improvement prediction routine applies an improvement to the improvement target activity. That is, the activity G is improved, and the results shown in FIG. 11A are obtained as the new activity improvement prediction results after the improvement of the activity G. In FIG. 11A, the underlines indicate the improved activity and the values improved over those shown in FIG. 10A.

Next, the business process improvement prediction routine returns to step 204 to repeat the above processing. Based on FIG. 11A which shows the new activity improvement prediction results after the improvement of the activity G, the times required along the respective activity paths after the improvement of the activity G are obtained as shown in FIG. 11B. In FIG. 11B, the underlines indicate the improved activity and improved value. Based on the times required along the respective activity paths shown in FIG. 11B, the path A→E→F→H is detected as the critical path.

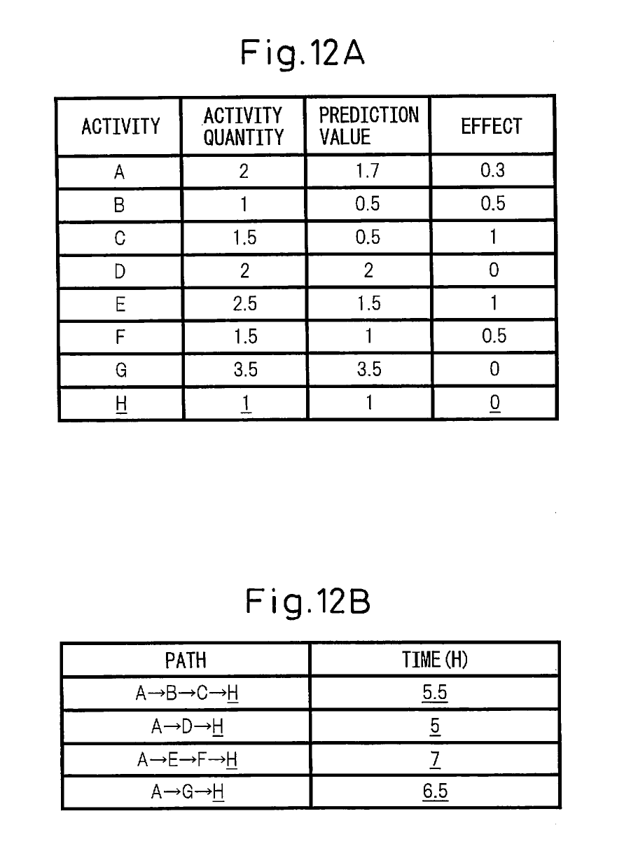

Next, by referring to the results of activity improvement prediction shown in FIG. 11A, the business process improvement prediction routine detects the activity H as the activity that yields the highest improvement effect within the path A→E→F→H (step 206). Then, the business process improvement prediction routine improves the activity H, and the results shown in FIG. 12A are obtained as the new activity improvement prediction results after the improvement of the activity H (steps 208 and 210).

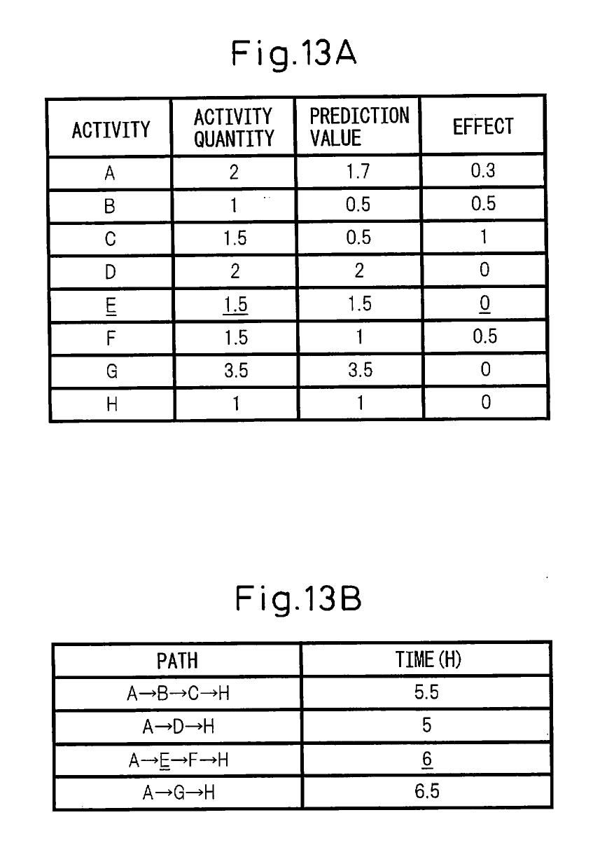

Then, based on FIG. 12A which shows the new activity improvement prediction results after the improvement of the activity H, the business process improvement prediction routine obtains the times required along the respective activity paths after the improvement of the activity H as shown in FIG. 12B, and detects the path A→E→F→H as the critical path (step 204). Next, by referring to the results of activity improvement prediction shown in FIG. 12A, the business process improvement prediction routine detects the activity E as the activity that yields the highest improvement effect within the path A→E→F→H, improves the activity E, and obtains the results shown in FIG. 13A as the new activity improvement prediction results after the improvement of the activity E (steps 206, 208, and 210).

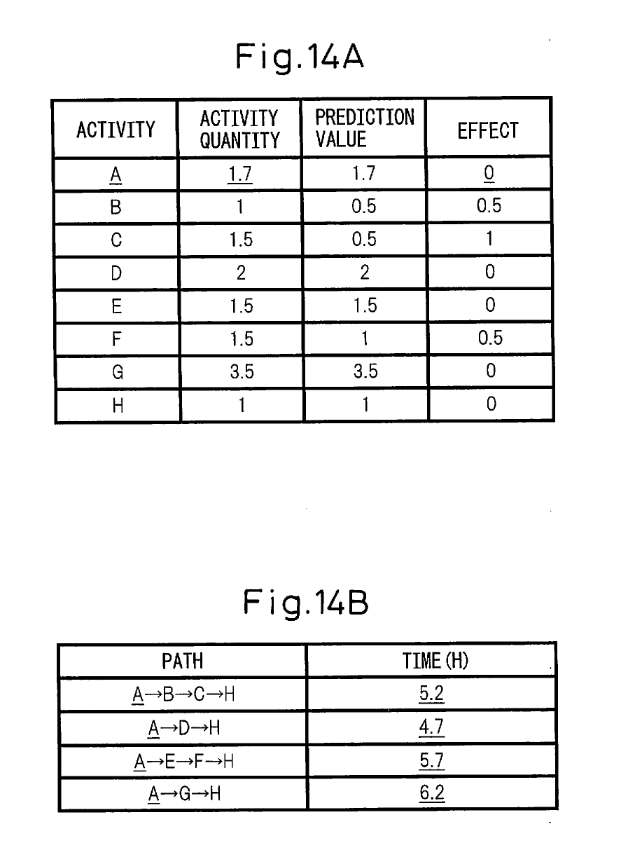

Further, based on FIG. 13A which shows the new activity improvement prediction results after the improvement of the activity E, the business process improvement prediction routine obtains the times required along the respective activity paths after the improvement of the activity E as shown in FIG. 13B, and detects the path A→G→H as the critical path (step 204). Next, by referring to the results of activity improvement prediction shown in FIG. 13A, the business process improvement prediction routine detects the activity A as the activity that yields the highest improvement effect within the path A→G→H, improves the activity A, and obtains the results shown in FIG. 14A as the new activity improvement prediction results after the improvement of the activity A (steps 206, 208, and 210).

Then, based on FIG. 14A which shows the new activity improvement prediction results after the improvement of the activity A, the business process improvement prediction routine obtains the times required along the respective activity paths after the improvement of the activity A as shown in FIG. 14B, and again detects the path A→G→H as the critical path (step 204). Next, by referring to the results of activity improvement prediction shown in FIG. 14A, the business process improvement prediction routine searches for an activity that yields the highest improvement effect within the path A→G→H, but terminates the processing because the effect is “0” for all the activities belonging to that path (steps 206 and 208).

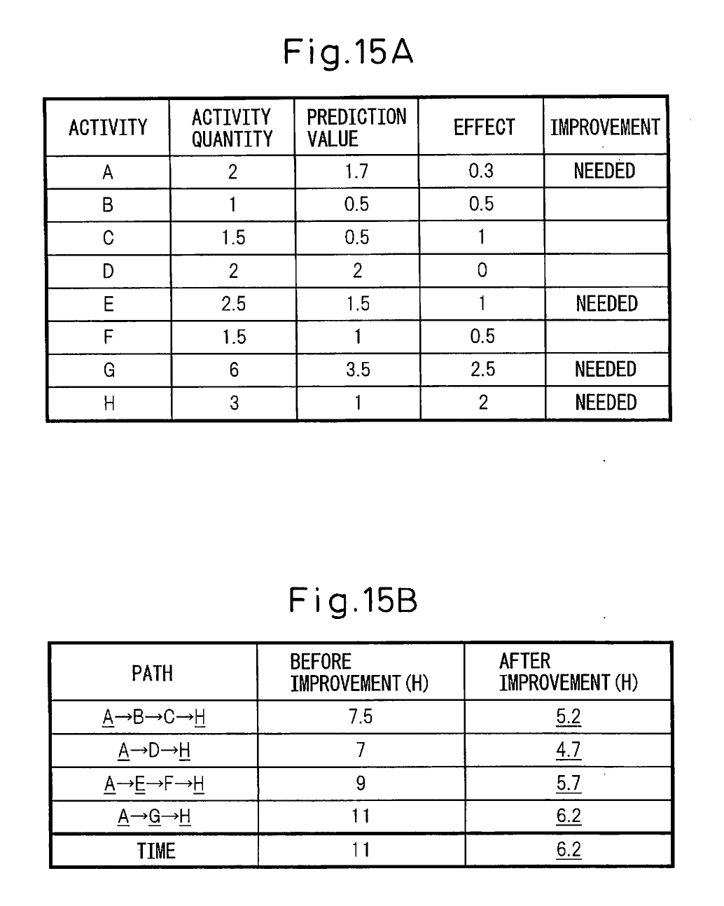

Finally, the business process improvement prediction routine outputs the results of business process improvement prediction to the input/output device 36 and/or the main storage device 32 or the auxiliary storage device 34 (step 212), whereupon the routine is terminated. The output results are shown, for example, by displaying the activities to be improved, as shown in FIG. 15A, and/or by displaying a prediction of how much the time required to perform each activity can be shortened, as shown in FIG. 15B.

In the above business process improvement prediction routine, step 204 constitutes a critical path detecting means for detecting a critical path in the business process under analysis. Steps 206 and 210 constitute an activity improving means for reflecting the activity improvement effect in the activity quantity of the activity that yields the greatest activity improvement effect of all the activities belonging to the critical path. Steps 208 and 212 constitute a business process improvement effect computing means for computing business process improvement effect by causing the critical path detecting means and the activity improving means to perform processing until the activity improvement effect becomes zero for all the activities belonging to the critical path.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A business process analysis apparatus comprising:
an activity database in which at least activity quantity, output type, and output quantity are stored by being associated with one another for each of a plurality of activities forming a business process;
a target activity selecting unit for selecting an activity belonging to the business process under analysis as an analysis target activity from within the activity database;
a target activity information acquiring unit for acquiring the activity quantity, output type, and output quantity of the analysis target activity;
a reference efficiency determining unit for retrieving from the activity database any activity having the same output type as the output type of the analysis target activity, obtaining activity efficiency based on the activity quantity and output quantity of the retrieved activity, and determining reference efficiency based on at least one activity efficiency thus obtained;
an activity improvement effect computing unit for computing activity improvement effect by calculating a difference between the activity quantity of the analysis target activity and the activity quantity that would be required if the analysis target activity were performed with the reference efficiency; and
a unit for causing the target activity information acquiring unit, the reference efficiency determining unit, and the activity improvement effect computing unit to perform processing on every analysis target activity selected by the target activity selecting unit.

2. A business process analysis apparatus according to claim 1, wherein the reference efficiency determining unit determines a maximum value of the at least one activity efficiency as the reference efficiency.

3. A business process analysis apparatus according to claim 1, wherein the reference efficiency determining unit determines an average value of the at least one activity efficiency as the reference efficiency.

4. A business process analysis apparatus according to claim 1, wherein the activity database stores the plurality of activities forming the business process by associating each activity with one another, and
the system further comprises:
a critical path detecting unit for detecting a critical path in the business process under analysis;
an activity improving unit for reflecting the activity improvement effect in the activity quantity of the activity that yields the greatest activity improvement effect of all the activities belonging to the critical path; and
a business process improvement effect computing unit for computing business process improvement effect by causing the critical path detecting unit and the activity improving unit to perform processing until the activity improvement effect becomes zero for all the activities belonging to the critical path.

5. A business process analysis method comprising:
constructing an activity database in which at least activity quantity, output type, and output quantity are stored by being associated with one another for each of a plurality of activities forming a business process;
selecting an activity belonging to the business process under analysis as an analysis target activity from within the activity database;
acquiring, as target activity information, the activity quantity, output type, and output quantity of the analysis target activity;
determining a reference efficiency by retrieving from the activity database any activity having the same output type as the output type of the analysis target activity, obtaining activity efficiency based on the activity quantity and output quantity of the retrieved activity, and determining the reference efficiency based on at least one activity efficiency thus obtained;
computing activity improvement effect by calculating a difference between the activity quantity of the analysis target activity and the activity quantity that would be required if the analysis target activity were performed with the reference efficiency; and
causing the target activity information acquiring process, the reference efficiency determining process, and the activity improvement effect computing process to be carried out on every analysis target activity selected in the target activity selecting process.

6. A business process analysis method according to claim 5, wherein the reference efficiency determining process determines a maximum value of the at least one activity efficiency as the reference efficiency.

7. A business process analysis method according to claim 5, wherein the reference efficiency determining process determines an average value of the at least one activity efficiency as the reference efficiency.

8. A business process analysis method according to claim 5, wherein the activity database constructing process constructs the activity database so that the plurality of activities forming the business process are stored by being associated with one another, and
the method further comprises:
detecting a critical path in the business process under analysis;
improving an activity by reflecting the activity improvement effect in the activity quantity of the activity that yields the greatest activity improvement effect of all the activities belonging to the critical path; and
computing a business process improvement effect by causing the critical path detecting process and the activity improving process to be carried out repeatedly until the activity improvement effect becomes zero for all the activities belonging to the critical path.

9. For use with a business process analysis system which analyzes a business process based on an activity database in which at least activity quantity, output type, and output quantity are stored by being associated with one another for each of a plurality of activities forming the business process, a storage medium storing a business process analysis program for causing the business process analysis system to implement the functions of;
a target activity selecting unit for selecting an activity belonging to the business process under analysis as an analysis target activity from within the activity database;
a target activity information acquiring unit for acquiring the activity quantity, output type, and output quantity of the analysis target activity;
a reference efficiency determining unit for retrieving from the activity database any activity having the same output type as the output type of the analysis target activity, obtaining activity efficiency based on the activity quantity and output quantity of the retrieved activity, and determining reference efficiency based on at least one activity efficiency thus obtained;
an activity improvement effect computing unit for computing activity improvement effect by calculating a difference between the activity quantity of the analysis target activity and the activity quantity that would be required if the analysis target activity were performed with the reference efficiency; and
a unit for causing the target activity information acquiring unit, the reference efficiency determining unit, and the activity improvement effect computing unit to perform processing on every analysis target activity selected by the target activity selecting unit.

10. A storage medium according to claim 9, wherein the reference efficiency determining unit determines a maximum value of the at least one activity efficiency as the reference efficiency.

11. A storage medium according to claim 9, wherein the reference efficiency determining unit determines an average value of the at least one activity efficiency as the reference efficiency.

12. A storage medium according to claim 9, wherein the activity database stores the plurality of activities forming the business process by associating each activity with one another, and
the business process analysis program causes the business process analysis system to further implement the functions of:
a critical path detecting unit for detecting a critical path in the business process under analysis;
an activity improving unit for reflecting the activity improvement effect in the activity quantity of the activity that yields the greatest activity improvement effect of all the activities belonging to the critical path; and
a business process improvement effect computing unit for computing business process improvement effect by causing the critical path detecting unit and the activity improving unit to perform processing until the activity improvement effect becomes zero for all the activities belonging to the critical path.
